(19) United States
(12) Patent Application Publication
(10) Pub. No.: US 2021/0103857 A1
(43) Pub. Date: Apr. 8, 2021

(54) AUTOMATED MODEL TRAINING DEVICE AND AUTOMATED MODEL TRAINING METHOD FOR TRAINING PIPELINE FOR DIFFERENT SPECTROMETERS

(71) Applicant: Coretronic Corporation, Hsin-Chu (TW)

(72) Inventors: Feng Wang, Hsin-Chu (TW); Yen-Chun Huang, Hsin-Chu (TW)

(73) Assignee: Coretronic Corporation, Hsin-Chu (TW)

(21) Appl. No.: 17/064,560

(22) Filed: Oct. 6, 2020

(30) Foreign Application Priority Data
Oct. 8, 2019 (CN) 201910948690.6

(51) Int. Cl. G06N 20/00; G01J 3/28

(52) U.S. Cl. CPC G06N 20/00; G01J 2003/283; G01J 3/28

(57) ABSTRACT

The invention provides an automated model training method for training a pipeline for different spectrometers. The automated model training method includes: obtaining first spectral data corresponding to a first spectrometer, and second spectral data corresponding to a second spectrometer; and training the pipeline for the first spectrometer and the second spectrometer according to the first spectral data and the second spectral data, wherein the pipeline corresponds to at least one candidate recognition model. The invention also provides an automated model training device.

### CROSS-REFERENCE TO RELATED APPLICATION

This application claims the priority benefit of China application serial no. 201910948690.6, filed on Oct. 8, 2019. The entirety of the above-mentioned patent application is hereby incorporated by reference herein and made a part of this specification.

### BACKGROUND

### 1. Technical Field

The invention relates to the technology of spectrometers, and more particularly relates to an automated model training device and an automated model training method for training a pipeline for different spectrometers.

### 2. Description of Related Art

The application of spectrometers relies on the quality of the recognition model used for detecting spectral characteristics, and different applications involve different spectral characteristics. Therefore, each application of spectrometers requires experts to establish a corresponding recognition model. The experts need to try various combinations of pre-processing models, machine learning models, and hyperparameters before they can generate a suitable recognition model, and the generated recognition model may not be the optimal one.

In addition, there are often differences between spectrometers, and when spectral measurements are performed, the measurement results are susceptible to the optical path of the scattered light. Therefore, the same recognition model is usually not used for different spectrometers, and the user is required to separately train or correct the recognition models for different spectrometers. As a result, the manufacturers are unable to produce spectrometers in large quantities, and need to spend a lot of time and effort to maintain numerous recognition models.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

In view of the above, the invention provides an automated model training device and an automated model training method for training a pipeline for different spectrometers so as to quickly establish an optimal recognition model and use the recognition model for different spectrometers.

Other objectives and advantages of the invention can be further understood by the technical features broadly embodied and described as follows.

In order to achieve one or part or all of the above or other objectives, an embodiment of the invention provides an automated model training method for training a pipeline for different spectrometers. The automated model training method includes: obtaining a first spectral data corresponding to a first spectrometer, and a second spectral data corresponding to a second spectrometer; and training the pipeline for the first spectrometer and the second spectrometer according to the first spectral data and the second spectral data, wherein the pipeline corresponds to at least one candidate recognition model.

In order to achieve one or part or all of the above or other objectives, an embodiment of the invention provides an automated model training device for training a pipeline for different spectrometers. The automated model training device includes: a transceiver, a processor, and a storage medium. The transceiver obtains a first spectral data and a second spectral data, wherein the first spectral data corresponds to a first spectrometer and the second spectral data corresponds to a second spectrometer. The storage medium stores a plurality of modules. The processor is coupled to the transceiver and the storage medium, and accesses and executes the modules, wherein the modules include a training module. The training module trains the pipeline for the first spectrometer and the second spectrometer according to the first spectral data and the second spectral data, wherein the pipeline corresponds to at least one candidate recognition model.

Based on the above, according to the invention, the optimal combination for a specific spectral characteristic can be automatically selected from a plurality of combinations of pre-processing algorithms, machine learning algorithms, and hyperparameters so as to generate the recognition model for detecting the specific spectral characteristic. Furthermore, the pipeline trained according to the invention can be used for different spectrometers, and the performance of the pipeline on different spectrometers can be estimated through the test value, which significantly reduces the costs of training and maintenance of the recognition model.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram showing an automated model training device for training a pipeline for different spectrometers according to an embodiment of the invention.

FIG. 2 is a schematic diagram showing training a recognition model with the automated model training device according to an embodiment of the invention.

FIG. 3 is a schematic diagram showing a first spectral data and a second spectral data according to an embodiment of the invention.

FIG. 4 is a schematic diagram showing calculating a value of a loss function corresponding to a candidate recognition model according to an embodiment of the invention.

FIG. 5 is a schematic diagram showing a value of a loss function corresponding to a second candidate recognition model according to an embodiment of the invention.

FIG. 6 is a schematic diagram showing a first spectral data, a second spectral data, and a third spectral data according to an embodiment of the invention.

FIG. 7 is a schematic diagram showing calculating a value of a loss function corresponding to a third candidate recognition model according to an embodiment of the invention.

FIG. 8 is a schematic diagram showing a value of a loss function corresponding to a fourth candidate recognition model according to an embodiment of the invention.

FIG. 9 is a flow chart showing an automated model training method for training a pipeline for different spectrometers according to an embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

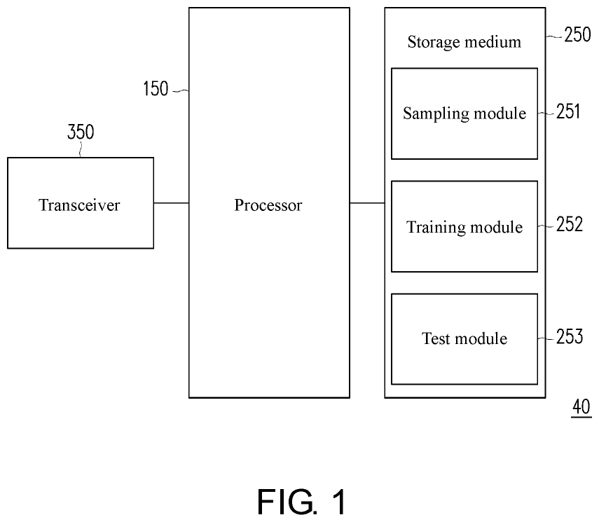

FIG. 1 is a schematic diagram showing an automated model training device 40 for training a pipeline for different spectrometers according to an embodiment of the invention. The automated model training device 40 is configured to generate a plurality of candidate recognition models that can be used for a plurality of spectrometers simultaneously, so as to select the pipeline corresponding to the optimal one of the candidate recognition models for use. The automated model training device 40 includes a processor 150, a storage medium 250, and a transceiver 350.

The processor 150 is, for example, a central processing unit (CPU), a programmable general purpose or special purpose micro control unit (MCU), a microprocessor, a digital signal processor (DSP), a programmable controller, an application specific integrated circuit (ASIC), a graphics processing unit (GPU), an arithmetic logic unit (ALU), a complex programmable logic device (CPLD), a field programmable gate array (FPGA), other similar components or a combination of the foregoing.

The storage medium 250 is, for example, a stationary or movable random access memory (RAM) in any form, a read-only memory (ROM), a flash memory, a hard disk drive (HDD), a solid state drive (SSD), other similar components or a combination of the foregoing, and is configured to store a plurality of modules or various applications executable by the processor 150. In the present embodiment, the storage medium 250 may store a plurality of modules including a sampling module 251, a training module 252, and a test module 253. The functions thereof will be described later.

The transceiver 350 transmits and receives signals in a wireless or wired manner. The transceiver 350 may perform operations such as low noise amplification, impedance matching, frequency mixing, upward or downward frequency conversion, filtering, amplification, and the like.

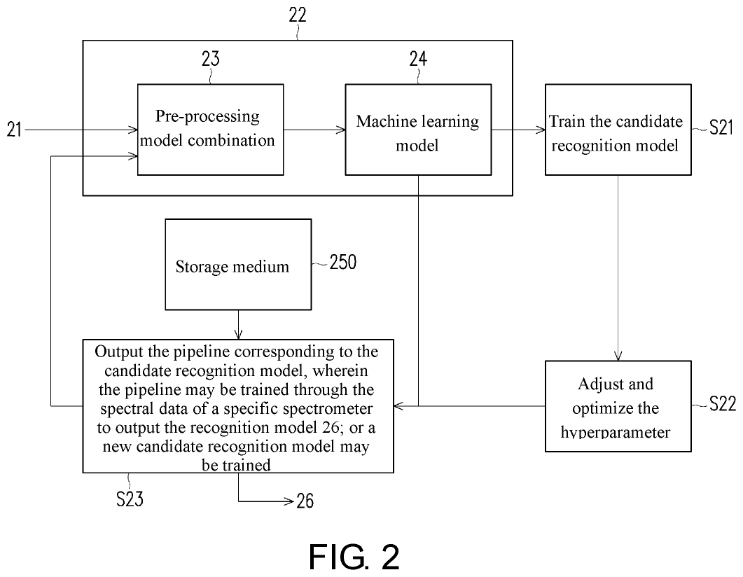

FIG. 2 is a schematic diagram showing training a recognition model 26 with the automated model training device 40 according to an embodiment of the invention. Referring to FIG. 1 and FIG. 2, the automated model training device 40 obtains spectral data 21 for training the recognition model 26 (for example, from a spectrometer) by the transceiver 350. The training module 252 in the storage medium 250 trains the recognition model 26 according to the spectral data 21.

Specifically, the storage medium 250 stores a plurality of pre-processing models for pre-processing the spectral data 21, wherein the pre-processing models may be associated with a smooth program, a wavelet program, a baseline correction program, a differentiation program, a standardization program or a random forest (RF) program. Nevertheless, the invention is not limited thereto.

Furthermore, the storage medium 250 may store a plurality of machine learning models for training a recognition model for the spectral data 21. The machine learning models include, for example, a regression model and a classification model. Nevertheless, the invention is not limited thereto.

The training module 252 may select one or more pre-processing models and sort the one or more pre-processing models to generate a pre-processing model combination 23 that includes at least one pre-processing model. For example, the training module 252 may select multiple pre-processing models to be combined into a form of the pre-processing model combination 23 as shown in Table 1. It is known from Table 1 that the form #1 composed of a smooth program, a wavelet program, a baseline correction program, a differentiation program, and a standardization program corresponds to a minimum mean square error (MSE). Therefore, in the present embodiment, the form #1 is the optimal form of the pre-processing model combination 23. Nevertheless, the invention is not limited thereto. In other embodiments, a form may include a different number of programs.

TABLE 1

| | | First | Second | Third | Fourth | |
|---|---|---|---|---|---|---|
| | MSE | program | program | program | program | Fifth program |
| #1 | 2.120 | Smooth | Wavelet | Baseline | Differen- | Standardization |
| | | | | correction | tiation | |
| #2 | 2.143 | Smooth | Wavelet | Differen- | Baseline | Standardization |
| | | | | tiation | correction | |
| #3 | 2.171 | Wavelet | Smooth | Differen- | Baseline | Standardization |
| | | | | tiation | correction | |
| #4 | 2.172 | Wavelet | Differen- | Smooth | Baseline | Standardization |
| | | | tiation | | correction | |
| #5 | 2.183 | Wavelet | Differen- | Baseline | Smooth | Standardization |
| | | | tiation | correction | | |

In addition, the training module 252 further selects a machine learning model 24. The training module 252 combines the pre-processing model combination 23 and the machine learning model 24 into a pipeline 22. The pipeline 22 also includes information such as a hyperparameter (or hyperparameter combination) corresponding to the pre-processing model combination 23 and a hyperparameter (or hyperparameter combination) corresponding to the machine learning model 24. Specifically, the hyperparameter combination is related to the user's setting of the machine learning model 24 and adjustment of data variables, which includes the number of layers of neural networks, the loss function, the size of the convolution kernel, the learning rate, and the like, for example.

After determining the composition of the pipeline 22, in Step S21, the training module 252 trains a candidate recognition model according to the spectral data 21. Specifically, the training module 252 divides the spectral data 21 into a training set, a verification set, and a test set. The training module 252 may train the pipeline 22 using the training set, thereby generating the candidate recognition model corresponding to the pipeline 22. The loss function used during training of the candidate recognition model is associated with, for example, a mean square error (MSE) algorithm, but the invention is not limited thereto.

Then, in Step S22, the training module 252 adjusts and optimizes the hyperparameter (or hyperparameter set) corresponding to the candidate recognition model of the pipeline 22 using the verification set of the spectral data 21. The training module 253 may determine the optimal hyperparameter (or optimal hyperparameter set) for the candidate recognition model according to algorithms such as a grid search algorithm, a permutation search algorithm, a random searching algorithm, a Bayesian optimization algorithm, a genetic algorithm, and a reinforcement learning algorithm.

After determining the optimal hyperparameter, in Step S23, the training module 252 uses the test set of the spectral data 21 to determine the performance of the pipeline 22 according to the pipeline 22 corresponding to the candidate recognition model. After obtaining the performance of the pipeline 22, the training module 252 determines whether to select the pipeline corresponding to the pipeline 22 corresponding to the candidate recognition model, wherein the pipeline may be trained through specific spectral data to output the recognition model 26. A specific method of determining the pipeline to be outputted will be described later. For example, the training module 252 may determine to output the pipeline corresponding to the candidate recognition model for user to use based on good performance of the candidate recognition model (for example, the mean square error of the loss function of the candidate recognition model is less than a threshold value), and the pipeline may be trained through the spectral data of a specific spectrometer to output the recognition model 26.

Alternatively, in Step S23, the training module 252 may select to train a new candidate recognition model, and select the pipeline corresponding to the optimal candidate recognition model from a plurality of candidate recognition models trained by the training module 252, wherein the pipeline may be trained through specific spectral data to be outputted as the recognition model 26. A specific method of determining the pipeline to be outputted will be described later.

When training a new candidate recognition model, the training module 252 first generates a new pipeline 22. For example, the training module 252 may generate a new pre-processing model combination 23 according to at least one of a plurality of pre-processing models and generate a new machine learning model 24 according to one of a plurality of machine learning models. Accordingly, the training module 252 generates a new pipeline 22 using the new pre-processing model combination 23 and the new machine learning model 24. After the training module 252 generates a plurality of candidate recognition models respectively corresponding to different pipelines, the training module 252 selects a specific candidate recognition model as the recognition model 26 in response to that the performance of the specific candidate recognition model is better than the performances of other candidate recognition models (for example, the loss function of the specific candidate recognition model has the minimum value).

In an embodiment, the training module 253 match the new pre-processing model combination 23 and the new machine learning model 24 according to algorithms such as a grid search algorithm, a permutation search algorithm, a random searching algorithm, a Bayesian optimization algorithm, a genetic algorithm and a reinforcement learning algorithm, so as to generate the new pipeline 22 and train the recognition model 26 according to the new pipeline 22. Since the composition of the pipeline 22 has many different forms, the training module 252 can quickly filter out the preferred composition of the pipeline 22 according to the above algorithms, thereby reducing the training time of the recognition model 26.

In another embodiment, the storage medium 250 may store a historical pipeline list corresponding to at least one pipeline, wherein the historical pipeline list records the compositions of the pipeline that the automated model training device 40 has used in the past. The training module 252 may select a historical pipeline from the historical pipeline list as the new pipeline 22 and train the recognition model 26 according to the new pipeline 22. In other words, the historical pipeline list helps the training module 252 find the optimal pipeline 22 more quickly.

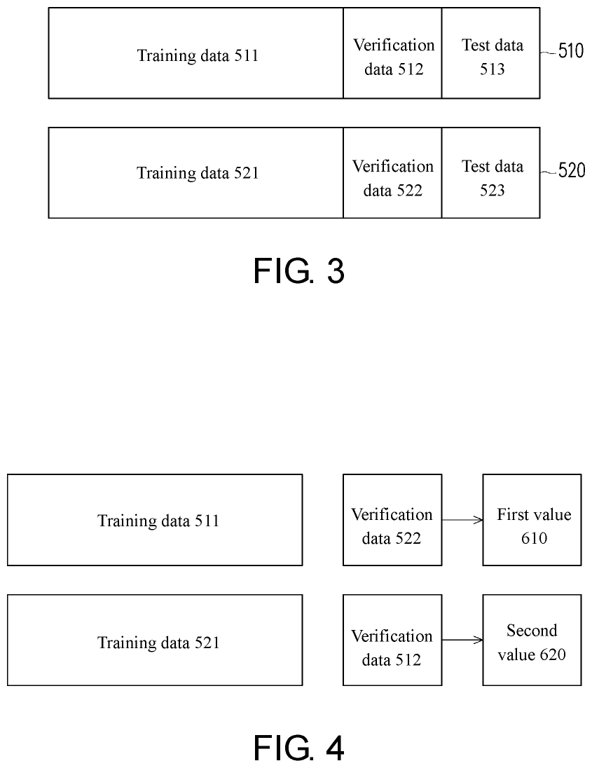

FIG. 3 is a schematic diagram showing first spectral data 510 and second spectral data 520 according to an embodiment of the invention. FIG. 4 is a schematic diagram showing calculating the value of the loss function corresponding to the candidate recognition model according to an embodiment of the invention.

Referring to FIG. 3 and FIG. 4, the processor 150 obtains the first spectral data 510 corresponding to the first spectrometer and the second spectral data 520 corresponding to the second spectrometer through the transceiver 350. The training module 252 trains the pipeline for the first spectrometer and the second spectrometer according to the first spectral data 510 and the second spectral data 520, wherein the pipeline corresponds to at least one candidate recognition model, and the candidate recognition model is composed of, for example, a pre-processing model combination (for example, the pre-processing model combination 23 as shown in FIG. 2) and a machine learning model (for example, the machine learning model 24 as shown in FIG. 2). The training module 252 may train the pipeline in a manner similar to Step S21 shown in FIG. 2.

In an embodiment, the sampling module 251 generates a training set and a verification set and trains the candidate recognition model according to the training set and the verification set. In order to train the pipeline that can be used for both the first spectrometer and the second spectrometer, wherein the pipeline corresponds to at least one candidate recognition model, the sampling module 251 associates the first spectral data 510 corresponding to the first spectrometer with at least one of the training set and the verification set, and associates the second spectral data 520 corresponding to the second spectrometer with at least one of the training set and the verification set.

For example, the sampling module 251 may divide the first spectral data 510 into training data 511, verification data 512, and test data 513, and divide the second spectral data 520 into training data 521, verification data 522, and test data 523. Next, the sampling module 251 may select the training data 511 as the training set for the candidate recognition model and the verification data 522 as the verification set for the candidate recognition model. The training module 252 may train a first model corresponding to the candidate recognition model according to the first spectral data 510 and the second spectral data 520. To be more specific, the training module 252 trains the first model for the first spectrometer and the second spectrometer according to the training data 511. The training module 252 may further verify the first model using the verification data 522 to calculate a first value 610 of the loss function corresponding to the first model.

In addition, the sampling module 251 may select the training data 521 as the training set of the candidate recognition model and the verification data 512 as the verification set of the candidate recognition model. The training module 252 may train a second model corresponding to the candidate recognition model according to the first spectral data 510 and the second spectral data 520. To be more specific, the training module 252 trains the second model for the first spectrometer and the second spectrometer according to the training data 521. The training module 252 may further verify the second model using the verification data 512 to calculate a second value 620 of the loss function corresponding to the second model.

After obtaining the first value 610 and the second value 620, the training module 252 determines a score of the pipeline corresponding to the candidate recognition model according to the first value 610 corresponding to the first model and the second value 620 corresponding to the second model. The score of the pipeline corresponding to the candidate recognition model is, for example, a function of the first value 610 and the second value 620. Therefore, the performance of the pipeline corresponding to the candidate recognition models can be inferred from the score of the pipeline corresponding to the candidate recognition model. For example, the score of the pipeline corresponding to the candidate recognition model may be an average of the first value 610 and the second value 620 (for example, the average of the loss function of the candidate recognition model), but the invention is not limited thereto.

In an embodiment, if the score of the pipeline corresponding to the candidate recognition model is less than a threshold value, the automated model training device 40 may directly output the pipeline corresponding to the candidate recognition model for use. In terms of use of the pipeline, after the user obtains the pipeline, the spectral data of a specific spectrometer may be trained to obtain the recognition model that is to be finally used for the specific spectrometer, and the spectral data of the specific spectrometer is related to one of the spectrometers corresponding to the spectral data used by the sampling module 251. For example, the first spectrometer may have the recognition model obtained by training the pipeline with the first spectral data.

In an embodiment, after the training module 252 determines the score of the pipeline corresponding to the candidate recognition model according to the first value 610 and the second value 620, the training module 252 may train a new candidate recognition model according to the first spectral data 510 and the second spectral data 520 and calculate the corresponding score. After obtaining a plurality of scores respectively corresponding to a plurality of candidate recognition models, the training module 252 may select a pipeline corresponding to at least one candidate recognition model having a lower score for use.

In an embodiment, after the training module 252 obtains the pipeline, the training module 252 trains the recognition model using the training data 511. The test module 253 may use the test data 513 to calculate a first test value of the loss function corresponding to the recognition model trained with the training data 511, and use the test data 523 to calculate a second test value of the loss function corresponding to the recognition model trained with the training data 511.

In addition, the training module 252 may train the pipeline using the training data 521. The test module 253 may use the test data 513 to calculate a third test value of the loss function corresponding to the recognition model trained with the training data 521, and further use the test data 523 to calculate a fourth test value of the loss function corresponding to the recognition model trained with the training data 521. The training module 252 may output the first test value, the second test value, the third test value, and the fourth test value to the user, as shown in Table 2. The user may evaluate the performance of the recognition model, particularly the performance of the pipeline on different spectrometers, trained with the training data 511 and the training data 521 according to at least one of the first test value, the second test value, the third test value, and the fourth test value.

TABLE 2

| | Test data 513 | Test data 523 |
|---|---|---|
| Training data 511 | First test value | Second test value |
| Training data 521 | Third test value | Fourth test value |

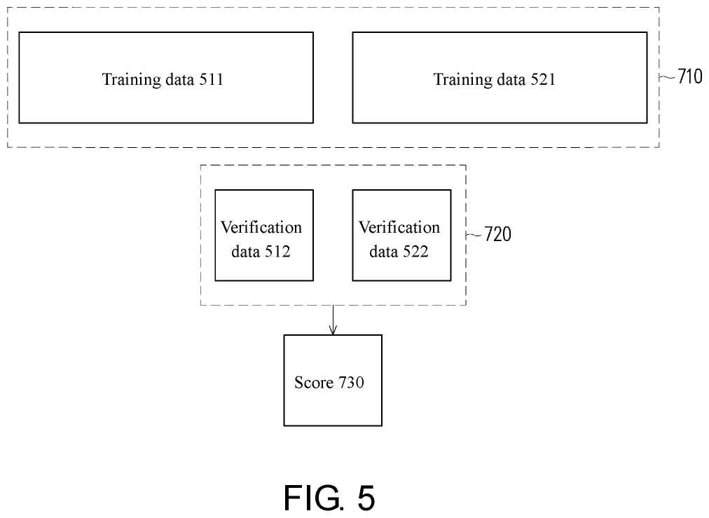

FIG. 5 is a schematic diagram showing another value of the loss function corresponding to the second candidate recognition model according to an embodiment of the invention. Referring to FIG. 3 and FIG. 5, the training module 252 trains a pipeline for the first spectrometer and the second spectrometer according to the first spectral data 510 and the second spectral data 520, wherein the pipeline corresponds to the second candidate recognition model.

In an embodiment, the sampling module 251 may combine the training data 511 and the training data 521 into a training set 710 for the second candidate recognition model. The sampling module 251 may further combine the verification data 512 and the verification data 522 into a verification set 720 for the second candidate recognition model. The training module 252 may train the second candidate recognition model for the first spectrometer and the second spectrometer according to the training set 710, and verify the second candidate recognition model using the verification set 720 to adjust the hyperparameter of the second candidate recognition model, and calculate a score 730 corresponding to the pipeline corresponding to the second candidate recognition model, wherein the score 730 is, for example, a function value of the loss function.

In an embodiment, if the score 730 of the loss function of the second candidate recognition model is less than a threshold value, the automated model training device 40 may directly output the second candidate recognition model as the recognition model to be used by the user.

In an embodiment, the training module 252 may train a new second candidate recognition model according to the first spectral data 510 and the second spectral data 520 and calculate a corresponding score. After obtaining a plurality of scores respectively corresponding to a plurality of second candidate recognition models, the training module 252 may select a pipeline corresponding to the second candidate recognition model having a lower score for use.

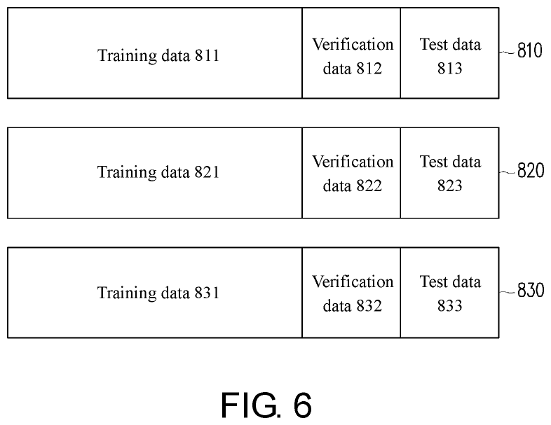

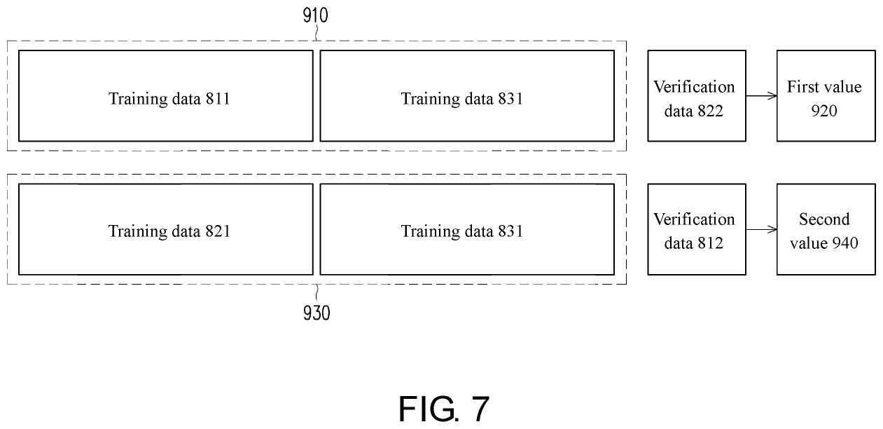

The automated model training device 40 of the invention may also be used to train a recognition model for more than two spectrometers. FIG. 6 is a schematic diagram showing first spectral data 810, second spectral data 820, and third spectral data 830 according to an embodiment of the invention. FIG. 7 is a schematic diagram showing calculating a value of a loss function corresponding to a third candidate recognition model according to an embodiment of the invention.

Referring to FIG. 6 and FIG. 7, the processor 150 obtains the first spectral data 810 corresponding to the first spectrometer, the second spectral data 820 corresponding to the second spectrometer, and the third spectral data 830 corresponding to the third spectrometer through the transceiver 350.

The training module 252 trains the pipeline for the first spectrometer, the second spectrometer, and the third spectrometer according to the first spectral data 810, the second spectral data 820, and the third spectral data 820, wherein the pipeline corresponds to at least one third candidate recognition model. The third candidate recognition model is composed of, for example, a pre-processing model combination (for example, the pre-processing model combination 23 as shown in FIG. 2) and a machine learning model (for example, the machine learning model 24 as shown in FIG. 2) (for example, the pipeline 22 as shown in FIG. 2). The training module 252 may train the third candidate recognition model in a manner similar to Step S21 shown in FIG. 2.

In an embodiment, the sampling module 251 generates a training set and a verification set and trains the third candidate recognition model according to the training set and the verification set. In order to train a candidate recognition model that can be used for the first spectrometer, the second spectrometer, and the third spectrometer, the sampling module 251 associates the first spectral data 810 corresponding to the first spectrometer with at least one of the training set and the verification set, associates the second spectral data 820 corresponding to the second spectrometer with at least one of the training set and the verification set, and associates the third spectral data 820 corresponding to the third spectrometer with at least one of the training set and the verification set.

For example, the sampling module 251 may divide the first spectral data 810 into training data 811, verification data 812, and test data 813, divide the second spectral data 820 into training data 821, verification data 822, and test data 823, and divide the third spectral data 830 into training data 831, verification data 832, and test data 833.

The sampling module 251 may combine the training data 811 and the training data 831 into a training set 910 for the third candidate recognition model, and use the verification data 822 as a verification set for the third candidate recognition model. The training module 252 may train a first model corresponding to the third candidate recognition model according to the first spectral data 810, the second spectral data 820, and the third spectral data 830. To be more specific, the training module 252 trains the first model for the first spectrometer, the second spectrometer, and the third spectrometer according to the training set 910. The training module 252 may further verify the first model using the verification data 822 to calculate a first value 920 of the loss function corresponding to the first model.

In addition, the sampling module 251 may combine the training data 821 and the training data 831 into a training set 930 for the third candidate recognition model, and uses the verification data 812 as a verification set for the third candidate recognition model. The training module 252 may train a second model corresponding to the third candidate recognition model according to the first spectral data 510, the second spectral data 820, and the third spectral data 830. To be more specific, the training module 252 trains the second model for the first spectrometer, the second spectrometer, and the third spectrometer according to the training set 930. The training module 252 may further verify the second model using the verification data 812 to calculate a second value 940 of the loss function corresponding to the second model.

After obtaining the first value 920 and the second value 940, the training module 252 determines a score of the pipeline corresponding to the third candidate recognition model according to the first value 920 corresponding to the first model and the second value 940 corresponding to the second model.

The score of the pipeline corresponding to the third candidate recognition model is, for example, a function of the first value 920 and the second value 940. For example, the score of the pipeline corresponding to the third candidate recognition model may be an average of the first value 920 and the second value 940 (that is, the average of the loss function of the third candidate recognition model), but the invention is not limited thereto.

In an embodiment, if the score of the pipeline corresponding to the third candidate recognition model is less than a threshold value, the automated model training device 40 may directly output the pipeline corresponding to the third candidate recognition model for use.

In an embodiment, after the training module 252 determines the score of the pipeline corresponding to the third candidate recognition model according to the first value 920 and the second value 940, the training module 252 may train a new third candidate recognition model according to the first spectral data 810, the second spectral data 820, and the third spectral data 830, and calculate the corresponding score. After obtaining a plurality of scores respectively corresponding to a plurality of third candidate recognition models, the training module 252 may select a pipeline corresponding to at least one third candidate recognition model having a lower score for use.

In an embodiment, after the training module 252 obtains the pipeline, the training module 252 trains the pipeline using the training data 811. The test module 253 may use the test data 813 to calculate a first test value of the loss function corresponding to the recognition model trained with the training data 811, use the test data 823 to calculate a second test value of the loss function corresponding to the recognition model trained with the training data 811, and use the test data 833 to calculate a third test value of the loss function corresponding to the recognition model trained with the training data 811.

In addition, the training module 252 may train the pipeline using the training data 821. The test module 253 may use the test data 813 to calculate a fourth test value of the loss function corresponding to the recognition model trained with the training data 821, use the test data 823 to calculate a fifth test value of the loss function corresponding to the recognition model trained with the training data 821, and use the test data 833 to calculate a sixth test value of the loss function corresponding to the recognition model trained with the training data 821.

Furthermore, the training module 252 may train the pipeline using the training data 831. The test module 253 may use the test data 813 to calculate a seventh test value of the loss function corresponding to the recognition model trained with the training data 831, use the test data 823 to calculate an eighth test value of the loss function corresponding to the recognition model trained with the training data 831, and use the test data 833 to calculate a ninth test value of the loss function corresponding to the recognition model trained with the training data 831. The test module 253 outputs the first test value to the ninth test value to the user, as shown in Table 3. The user may evaluate the performance of the recognition model, particularly the performance of the pipeline on different spectrometers, trained with the training data 811, the training data 821, and the training data 831 according to at least one of the first test value to the ninth test value.

TABLE 3

| | Test data 813 | Test data 823 | Test data 833 |
|---|---|---|---|
| Training data 811 | First test value | Second test value | Third test value |
| Training data 821 | Fourth test value | Fifth test value | Sixth test value |
| Training data 831 | Seventh test value | Eighth test value | Ninth test value |

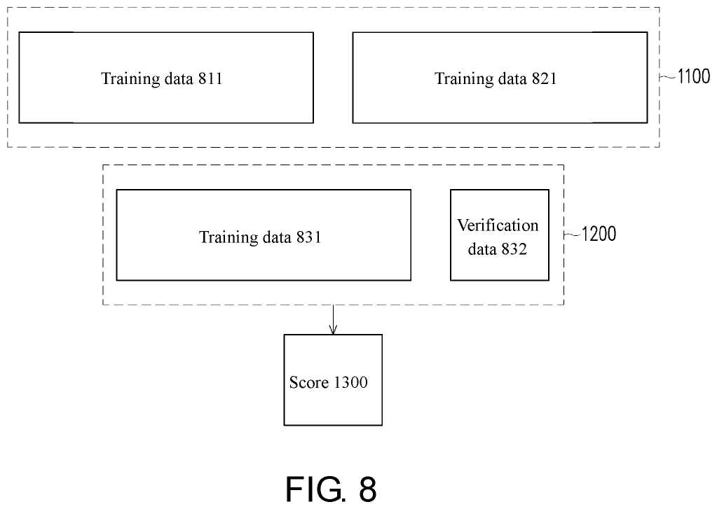

FIG. 8 is a schematic diagram showing a value of a loss function corresponding to a fourth candidate recognition model according to an embodiment of the invention. Referring to FIG. 6 and FIG. 8, the training module 252 trains the pipeline for the first spectrometer, the second spectrometer, and the third spectrometer according to the first spectral data 810, the second spectral data 820, and the third spectral data 830, wherein the pipeline corresponds to the fourth candidate recognition model.

In an embodiment, the sampling module 251 may combine the training data 811 and the training data 821 into a training set 1100 for the fourth candidate recognition model. The sampling module 251 may further combine the training data 831 and the verification data 832 into a verification set 1200 for the fourth candidate recognition model. The training module 252 may train the pipeline for the first spectrometer, the second spectrometer, and the third spectrometer according to the training set 1100, wherein the pipeline corresponds to the fourth candidate recognition model. The training module 252 may verify the fourth candidate recognition model using the verification set 1200 to calculate a score 1300 corresponding to the pipeline corresponding to the fourth candidate recognition model, wherein the score 1300 is, for example, a function value of the loss function.

In an embodiment, if the score 1300 of the loss function of the fourth candidate recognition model is less than a threshold value, the automated model training device 40 may directly output the pipeline corresponding to the fourth candidate recognition model for use.

In an embodiment, the training module 252 may train a new fourth candidate recognition model according to the first spectral data 810, the second spectral data 820, and the third spectral data 830, and calculate a corresponding score. After obtaining a plurality of scores respectively corresponding to a plurality of fourth candidate recognition models, the training module 252 may select the pipeline corresponding to the fourth candidate recognition model having a lower score for use.

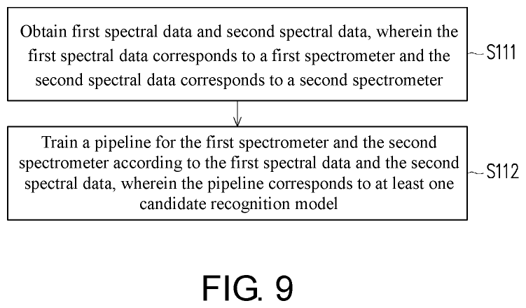

FIG. 9 is a flow chart showing an automated model training method for training a pipeline for different spectrometers according to an embodiment of the invention, wherein the automated model training method may be performed by the automated model training device 40 as shown in FIG. 1. In Step S111, first spectral data and second spectral data are obtained, wherein the first spectral data corresponds to a first spectrometer and the second spectral data corresponds to a second spectrometer. In Step S112, a pipeline for the first spectrometer and the second spectrometer is trained according to the first spectral data and the second spectral data, wherein the pipeline corresponds to at least one candidate recognition model.

In conclusion, according to the invention, the optimal combination for a specific spectral characteristic can be automatically selected from a plurality of combinations of pre-processing algorithms, machine learning algorithms, and hyperparameters so as to generate the recognition model for detecting the specific spectral characteristic. Furthermore, the pipeline trained according to the invention can be used for different spectrometers, and the performance of the pipeline on different spectrometers can be estimated through the test value, which significantly reduces the costs of training and maintenance of the recognition model.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An automated model training method for training a pipeline for different spectrometers, wherein the automated model training method is executed by a processor, the automated model training method comprising:
obtaining a first spectral data and a second spectral data, wherein the first spectral data corresponds to a first spectrometer and the second spectral data corresponds to a second spectrometer; and
training the pipeline for the first spectrometer and the second spectrometer according to the first spectral data and the second spectral data, wherein the pipeline corresponds to at least one candidate recognition model.

2. The automated model training method according to claim 1, further comprising:
generating a training set and a verification set, wherein the first spectral data and the second spectral data are respectively associated with at least one of the training set and the verification set; and
training at least one candidate recognition model according to the training set and the verification set.

3. The automated model training method according to claim 2, further comprising:
obtaining a third spectral data corresponding to a third spectrometer, wherein the third spectral data is associated with at least one of the training set and the verification set; and
training the at least one candidate recognition model for the third spectrometer according to the training set and the verification set.

4. The automated model training method according to claim 1, further comprising:
training a first candidate recognition model according to the first spectral data and the second spectral data;
calculating a first value of a loss function according to first training data associated with the first spectral data and a second verification data associated with the second spectral data;
calculating a second value of the loss function according to second training data associated with the second spectral data and a first verification data associated with the first spectral data; and
determining a first score of the first candidate recognition model according to the first value and the second value.

5. The automated model training method according to claim 1, further comprising:
obtaining a plurality of pieces of spectral data respectively corresponding to a plurality of spectrometers; and
training a first candidate recognition model according to the first spectral data, the second spectral data, and the plurality of pieces of spectral data, comprising:
calculating a first value of a loss function according to a first training set associated with the first spectral data and the plurality of pieces of spectral data and a second verification data associated with the second spectral data;
calculating a second value of the loss function according to a second training set associated with the second spectral data and the plurality of pieces of spectral data and a first verification data associated with the first spectral data; and
determining a first score of the first candidate recognition model according to the first value and the second value.

6. The automated model training method according to claim 5, further comprising:
training a second candidate recognition model for the first spectrometer, the second spectrometer and the plurality of spectrometers according to the first spectral data, the second spectral data and the plurality of pieces of spectral data; and
selecting the first candidate recognition model as the pipeline in response to that the first score of the first candidate recognition model is less than a second score of the second candidate recognition model.

7. The automated model training method according to claim 1, further comprising:
calculating a first test value of a loss function according to first test data corresponding to the first spectral data;
calculating a second test value of the loss function according to second test data corresponding to the second spectral data; and
outputting the first test value and the second test value.

8. The automated model training method according to claim 1, wherein the pipeline comprises a pre-processing model and a machine learning model.

9. The automated model training method according to claim 8, further comprising generating the machine learning model according to one of a random searching algorithm, a Bayesian optimization algorithm, a genetic algorithm, and a reinforcement learning algorithm.

10. The automated model training method according to claim 7, further comprising generating the pre-processing model according to at least one of a smooth program, a wavelet program, a baseline correction program, a differentiation program, a standardization program, and a random forest program.

11. The automated model training method according to claim 1, wherein a loss function for training the pipeline is associated with a mean square error algorithm.

12. A spectrometer, comprising a recognition model trained according to the first spectral data by the automated model training method according to claim 1.

13. An automated model training device for training a pipeline for different spectrometers, the automated model training device comprising:
a transceiver obtaining first spectral data and second spectral data, wherein the first spectral data corresponds to a first spectrometer and the second spectral data corresponds to a second spectrometer;
a storage medium storing a plurality of modules; and
a processor coupled to the transceiver and the storage medium, and accessing and executing the plurality of modules, wherein the plurality of modules comprise:
a training module training the pipeline for the first spectrometer and the second spectrometer according to the first spectral data and the second spectral data, wherein the pipeline corresponds to at least one candidate recognition model.

14. The automated model training device according to claim 13, wherein the plurality of modules further comprise:
a sampling module generating a training set and a verification set, wherein the first spectral data and the second spectral data are respectively associated with at least one of the training set and the verification set, wherein
the training module trains the at least one candidate recognition model according to the training set and the verification set.

15. The automated model training device according to claim 14, wherein the transceiver further obtains third spectral data corresponding to a third spectrometer, wherein
the third spectral data is associated with at least one of the training set and the verification set; and
the training module trains the at least one candidate recognition model for the third spectrometer according to the training set and the verification set.

16. The automated model training device according to claim 13, wherein the training module trains a first candidate recognition model according to the first spectral data and the second spectral data, comprising:
the training module calculates a first value of a loss function according to first training data associated with the first spectral data and a second verification data associated with the second spectral data;
the training module calculates a second value of the loss function according to second training data associated with the second spectral data and a first verification data associated with the first spectral data; and
the training module determines a first score of the first candidate recognition model according to the first value and the second value.

17. The automated model training device according to claim 13, wherein the transceiver further obtains a plurality of pieces of spectral data respectively corresponding to a plurality of spectrometers, wherein
the training module trains a first candidate recognition model according to the first spectral data, the second spectral data, and the plurality of pieces of spectral data, comprising:
the training module calculates a first value of a loss function according to a first training set associated with the first spectral data and the plurality of pieces of spectral data and a second verification set associated with the second spectral data;
the training module calculates a second value of the loss function according to a second training set associated with the second spectral data and the plurality of pieces of spectral data and a first verification set associated with the first spectral data; and
the training module determines a first score of the first candidate recognition model according to the first value and the second value.

18. The automated model training device according to claim 17, further comprising:
the training module trains a second candidate recognition model for the first spectrometer, the second spectrometer, and the plurality of spectrometers according to the first spectral data, the second spectral data, and the plurality of pieces of spectral data; and
the training module selects the first candidate recognition model as the pipeline in response to that the first score of the first candidate recognition model is less than a second score of the second candidate recognition model.

19. The automated model training device according to claim 13, wherein the plurality of modules further comprise:
a test module calculating a first test value of a loss function according to first test data corresponding to the first spectral data, calculating a second test value of the loss function according to second test data corresponding to the second spectral data, and outputting the first test value and the second test value.

20. The automated model training device according to claim 13, wherein the pipeline comprises a pre-processing model and a machine learning model.

21. The automated model training device according to claim 20 wherein the training module generates the machine learning model according to one of a random searching algorithm, a Bayesian optimization algorithm, a genetic algorithm, and a reinforcement learning algorithm.

22. The automated model training device according to claim 20, wherein the training module generates the pre-processing model according to at least one of a smooth program, a wavelet program, a baseline correction program, a differentiation program, a standardization program, and a random forest program.

23. The automated model training device according to claim 13, wherein a loss function for training the pipeline is associated with a mean square error algorithm.

24. A spectrometer, comprising a recognition model obtained by training the pipeline according to the first spectral data with the automated model training device according to claim 13.
